(19) United States
(12) Patent Application Publication
(10) Pub. No.: US 2006/0198386 A1
(43) Pub. Date: Sep. 7, 2006

(54) System and method for distributed information handling system cluster active-active master node

(76) Inventors: Tong Liu, Austin, TX (US); Onur Celebioglu, Austin, TX (US); Yung-Chin Fang, Austin, TX (US)

Correspondence Address: HAMILTON & TERRILE, LLP, P.O. BOX 203518, AUSTIN, TX, 78720, US

(21) Appl. No.: 11/069,770

(22) Filed: Mar. 1, 2005

(51) Int. Cl. H04L 12/56; H04L 12/28

(52) U.S. Cl. 370/419

(57) ABSTRACT

Computing nodes, such as plural information handling systems configured as a High Performance Computing Cluster (HPCC), are managed with plural master nodes configured to have active-active interaction. A resource manager of each of the plural master nodes is operable to simultaneously assign computing node resources to job requests. Reservations are made by a job scheduler in a table of a storage common to the active-active master nodes to avoid conflicts between master nodes and then reserved computing resources are assigned for management by the reserving master node resource manager. A failure manager monitors the master nodes to detect a failure, such as by a lack of communication from a master node for a predetermined time, and recovers a failed master node by assigning the jobs associated with the failed master node to an operating master node.

### BACKGROUND OF THE INVENTION

1. Field of the Invention

The present invention relates in general to the field of information handling system clusters, and more particularly to a system and method for distributed information handling system cluster active-active master node.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems typically are used as discrete units that operate independently to process and store information. Increasingly, information handling systems are interfaced with each other through networks, such as local area networks that have plural client information handling systems supported with one or more central server information handling systems. For instance, businesses often interconnect employee information handling systems through a local area network in order to centralize the storage of documents and communication by e-mail. As another example, a web site having substantial traffic sometimes coordinates requests to the web site through plural information handling systems that cooperate to respond to the requests. As requests arrive at a managing server, the requests are allocated to supporting servers that handle the requests, typically in an ordered-queue. More recently, information handling systems have been interfaced as High Performance Computing Clusters (HPCC) in which plural information handling systems perform complex operations by combining their processing power under the management of a single master node information handling system. The master node assigns tasks to information handling systems of its cluster, such as distributing jobs, handling all file input/output, and managing computing nodes, so that multiple information handling systems execute an application much like a supercomputer, such as a weather prediction application.

One difficulty that arises with coordination of plural information handling systems is that failure of a managing information handling system often results in failure of managed information handling systems due to an inability to access the managed information handling systems. A so-called single point of failure (SPOF) is especially undesirable when high-availability is critical. A related difficulty sometimes results from overloading of a managing information handling system when a large number of transactions are simultaneously initiated or otherwise coordinated through the managing information handling system. To avoid or at least reduce the impact of a failure of a managing node, various architectures use varying degrees of redundancy. Various Linux projects, such as Linux-HA and Linux Virtual Server, provide a failover policy in a Linux cluster so that assignment of tasks continues on a node-by-node basis in the event of a managing node failure, however these projects will not work with an HPCC architecture in which tasks are allocated to multiple information handling systems. Load Sharing Facility from Platform Computing Inc. and High Availability Open Source Cluster Application Resources (HA-OSCAR) are a job management applications that run on a HPCC master node to provide an active-standby master node architecture in which a standby master node recovers operations in the event of a failed master node. However, the active-standby HPCC architecture disrupts management of computing nodes during the transition from a standby to an active state and typically loses tasks in progress.

### SUMMARY OF THE INVENTION

Therefore a need has arisen for a system and method which provides an active-active HPCC master node architecture.

In accordance with the present invention, a system and method are provided which substantially reduce the disadvantages and problems associated with previous methods and systems for managing information handling system clusters. A distributed active-active master node architecture supports simultaneous management of computing node resources by plural master nodes for improved management and reliability of clustered computing nodes.

More specifically, plural master nodes of a High Performance Computing Cluster (HPCC) interface with each other and common storage to manage assignment and performance of computing job requests. A resource manager associated with each master node determines computing resources of computing nodes that are desired to perform a job request. A job scheduler reserves the desired computing resources in storage common to the plural master nodes and confirms that a conflict does not exist for the resources in a reservation or assignment by another master node. Once the availability of desired resources is confirmed, the resource manager assigns and manages the resources to perform the job request. During operation of a job request by a master node, failure managers associated with the other master nodes monitor the operation of the master node to detect a failure. Upon detection of a failed master node, the jobs under management by that master node are assigned to an operating master node by reference to the common storage.

The present invention provides a number of important technical advantages. One example of an important technical advantage is that plural master nodes of a HPCC information handling system simultaneously manage computing resources of common computing nodes. The availability of plural master nodes reduces the risk of a slow down of computing jobs caused by a bottleneck at a master node. Plural master nodes also reduces the risk of a failure of the information handling system by avoiding the single point of failure of a single master node. The impact from a failed master is reduced since the use of common storage by the master nodes allows an operating master node to recover jobs associated with the failed master node without the loss of information associated with the computing job.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of active-active master nodes managing computing resources of plural computing nodes; and

FIG. 2 depicts a flow diagram of a process for active-active master node management of computing resources.

### DETAILED DESCRIPTION

A High Performance Computing Cluster (HPCC) information handling system has the computing resources of plural computing nodes managed with plural active master nodes. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

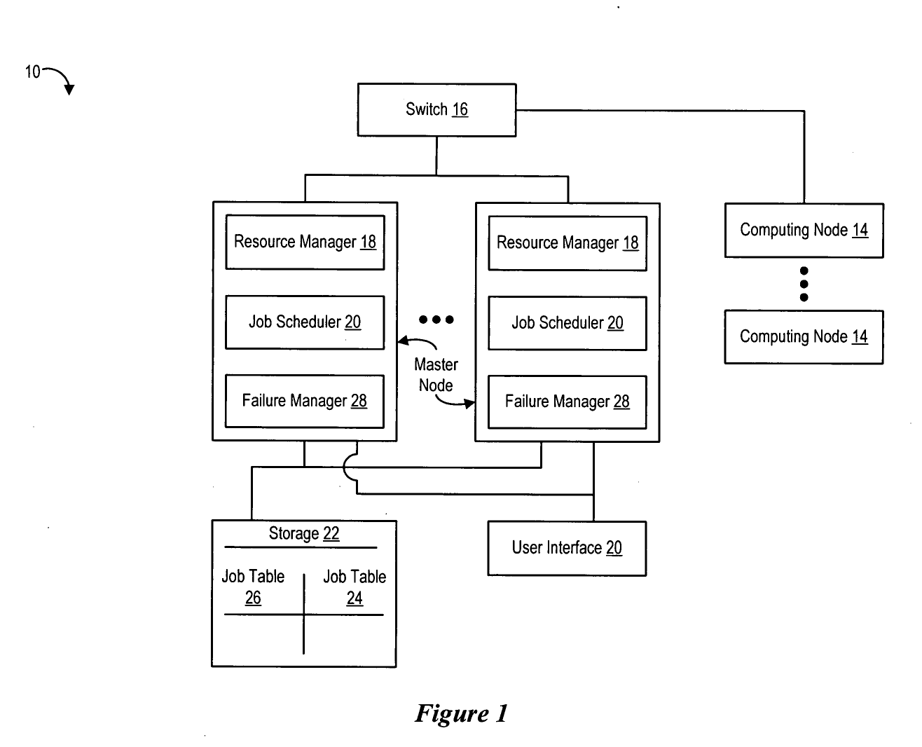

Referring now to FIG. 1, a block diagram depicts a HPCC information handling system 10 having plural active-active master nodes 12 managing computing resources of plural computing nodes 14. Master nodes 12 are information handling systems that manage computing resources of computing nodes 14, which are information handling systems that accept and perform computing jobs. Computing jobs are communicated from master nodes 12 through switch 16 to computing nodes 14 and results of the computing jobs are returned from computing nodes 14 through switch 16 to master nodes 12. A resource manager 18 on each master node 12 assigns computing resources of computing nodes 14 to jobs and manages performance of the jobs. For example, resource manager 18 assigns plural computing nodes 14 to a job in an HPCC configuration and manages communication of results between computing nodes 14 through switch 16. Job requests are input to master nodes 12 through a user interface 20, such as by determining the master node 12 having the best capacity to manage a job request with the least interference by other pending job requests. Results of a completed job request are made available to a user through user interface 20.

Resource managers 18 assign and manage jobs with computing nodes 14 applied as a HPCC configuration, however, allocation of computing resources between jobs is further managed by a reservation system enforced on resource managers 12 by a job scheduler 20. Job scheduler 20 uses a token system to reserve desired computing resources so that different resource managers 18 do not attempt to simultaneously use the same computing resources. For instance, when a job request is received from user interface 20, resource manager determines the desired computing resources and requests an assignment of the resources from job scheduler 20. Job scheduler 20 saves tokens for the desired resources in a token table 24 of a storage 22 based on the currently assigned computing resources of a job table 26. Job scheduler 20 waits a predetermined time and then confirms that another job scheduler 20 has not reserved tokens for the desired computing resources or otherwise assigned the desired computing resources to a job in job table 26. Once job scheduler 20 confirms that the reserved computing resources remain available, resource manager 12 is allowed to assign the computing resources as a HPCC configuration. In order to avoid conflicting use of computing resources of computing nodes 14, storage 22 is common to all master nodes 12 and all storage related caches are disabled to avoid potential cache coherence difficulties.

The availability of plural master nodes 12 improves HPCC performance by avoiding bottlenecks at the management of computing nodes 14. In addition, the availability of plural master nodes reduces the risk of failure of a job by allowing an operating master node 12 to recover jobs managed by a failed master node 12. A failure manager running on each master node 12 monitors communication from the other master nodes to detect a failure. For instance, failure manager 28 monitors communications across switch 16 to detect messages having the network address of other master nodes 12 and determines that a master node 12 has failed if no communications are detected with the address of the master node for a predetermined time period. For instance, failure manager 28 attempts to detect and recover a failed master node 12 within three to eight seconds of a failure, with eight seconds exceeding the Remote Procedure Call (RPC) timeout used for NFS access so that no file access will be lost. Upon detection of a failed master node 12, failure manager 28 recovers the failure by assuming jobs in job table 26 that are associated with the failed master node. The use of redundant storage 22 that is common to all master nodes ensures that consistency of data is maintained during recovery of jobs associated with a failed master node.

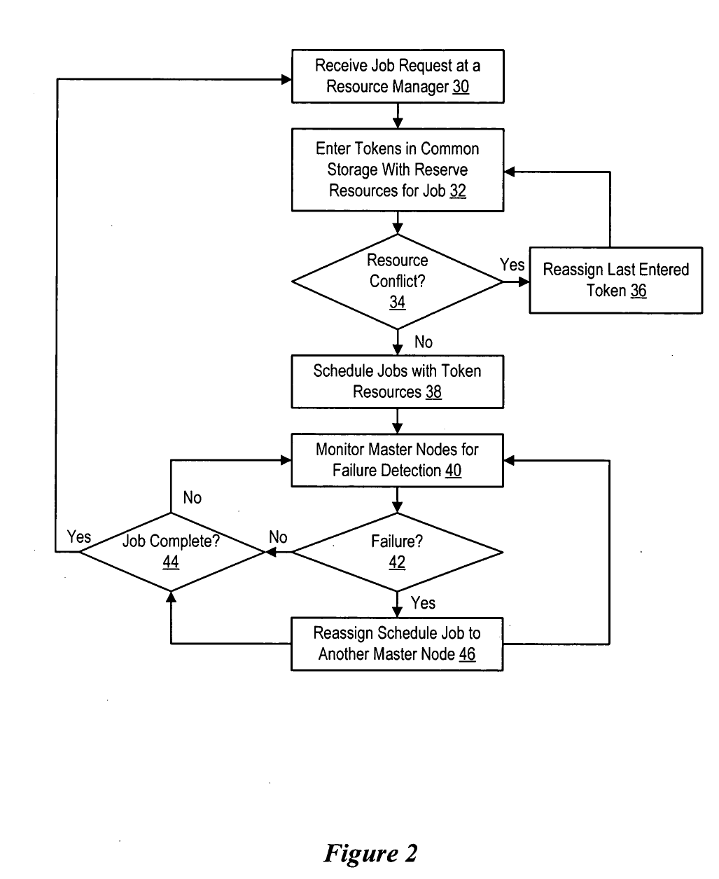

Referring now to FIG. 2, a flow diagram depicts a process for active-active master node management of computing resources. The process begins at step 30 with the receipt of a job request at a master node resource manager. Job requests are distributed between the plural master nodes based upon the available master node resources. The process continues to step 32 at which the computing resources desired to perform the job are determined and tokens are entered into storage common to the master nodes to reserve the desired computing resources. At step 34 a determination is made of whether the reserved computing resources conflict with other reservations or resource assignments. If a conflict exists, the process goes to step 36 for resolution of the conflict, such as by re-assignment of the job to other available computing resources at step 32. If no conflict exists, the process continues to step 38 where the job is schedule with the computing resources reserved by the tokens. At step 40, as the job is performed the master nodes monitor each other to detect a master node failure. If a failure is not detected at step 42 then the process continues to step 44 to determine if the job is complete. If the job is not complete, the process returns to step 40 for continued monitoring of master node operation. If the job is complete, the process returns to step 30 to standby for new job requests. If at step 42 a failure is detected, the process continues to step 46 for a reassignment of the management of the job to an operating master node. From step 46, the recovering master node returns to step 44 to continue with the job through completion by reference to storage used in common with the failed master node.

Although the present invention has been described in detail, it should be understood that various changes, substitutions and alterations can be made hereto without departing from the spirit and scope of the invention as defined by the appended claims.

What is claimed is:

1. An information handling system comprising:
plural computing nodes having computing resources operable to perform jobs assigned by a master node;
plural master nodes interfaced with each other and with the computing nodes, each master node having a resource manager operable to accept job requests, the resource managers further operable to simultaneously assign the job requests to the computing resources and manage performance of the job requests by the computing resources; and
a job scheduler associated with each of the plural master nodes and operable to prevent simultaneous assignment of job requests by different of the resource managers to the same computing resources.

2. The information handling system of claim 1 further comprising storage interfaced with each of the plural master nodes, the storage having a job table of job requests and computing resources associated with the job requests, wherein each job scheduler prevents simultaneous assignment of job requests by reference to the job table.

3. The information handling system of claim 2 further comprising a token table in the storage, the job schedulers further operable to reserve computing resources by reference to the token table and to assign computing resources by reference to the job table.

4. The information handling system of claim 2 further comprising a failure manager associated with each of the plural master nodes, each failure manager operable to monitor each of the plural master nodes to detect a failure of one or more of the master nodes and to take over managing of performance of job requests in the job table that are associated with a failed master node.

5. The information handling system of claim 4 wherein the failure manager monitors each of the plural master nodes by detecting communication from each of the plural master nodes at least once per predetermined time period.

6. The information handling system of claim 4 wherein each of the master nodes further has one or more storage caches, the storage caches disabled to prevent cache coherence difficulties in the event of a master node failure.

7. The information handling system of claim 1 further comprising a user interface operable to communicate job request information from a user to any of the master nodes.

8. The information handling system of claim 7 wherein the user interface selects a master node for a job request based at least in part on available master node resources.

9. The information handling system of claim 1 wherein the plural computing nodes are configured as a High Performance Computing Cluster.

10. A method for managing plural computing nodes of a High Performance Computing Cluster with plural master nodes, the method comprising:
receiving plural job requests at each of the plural master nodes;
reserving computing node resources for each job request with the master node that received the job request;
confirming that the reserved computing node resources do not conflict with each other;
assigning the computing node resources to the job requests as reserved.

11. The method of claim 10 wherein reserving computing resources further comprises:
checking storage common to the plural master nodes to determine unreserved computing node resources;
determining computing node resources desired for a job request; and
storing reservations for the desired computing node resources in the storage common to the plural master nodes.

12. The method of claim 11 wherein confirming further comprises checking the storage common to the plural master nodes a predetermined time after the storing reservations to determine that plural reservations do not exist for the desired computing node resources.

13. The method of claim 10 wherein assigning the computing node resources further comprises storing computing node resource assignments in the storage common to the plural master nodes.

14. The method of claim 13 further comprising:
monitoring the plural master nodes for failure;
detecting failure of a master node; and
assigning management of the computing node resources associated with the failed master node to an operating master node.

15. The method of claim 14 wherein monitoring further comprises detecting communications from each of the plural master nodes within a predetermined time period.

16. The method of claim 15 wherein the predetermined time period comprises a time greater than the time associated with Remote Procedure Call timeout.

17. The method of claim 10 further comprising disabling storage related caches of each master node.

18. An information handling system comprising:
a resource manager operable to assign computing jobs to computing resources of plural computing nodes and to manage the performance of the computing jobs by the computing resources; and
a job scheduler interfaced with the resource manager and operable to coordinate allocation of computing resources between the resource manager and one or more associated information handling systems that are also operable to assign computing jobs to the computing resources.

19. The information handling system of claim 18 further comprising a failure manager interfaced with the resource manager, the failure manager operable to detect failure of the one or more associated information handling systems and to recover the computing jobs of the associated information handling systems with the resource manager.

20. The information handling system of claim 19 wherein the computing nodes are information handling systems configured as a High Performance Computing Cluster.
